(19) United States
(12) Patent Application Publication
(10) Pub. No.: US 2015/0278846 A1
(43) Pub. Date: Oct. 1, 2015

(54) LOYALTY PROGRAM SYSTEM AND METHOD

(71) Applicant: Gilles Payette, Mascouche (CA)

(72) Inventor: Gilles Payette, Mascouche (CA)

(21) Appl. No.: 14/283,768

(22) Filed: May 21, 2014

Related U.S. Application Data
(60) Provisional application No. 61/972,549, filed on Mar. 31, 2014.

(51) Int. Cl. G06Q 30/02

(52) U.S. Cl. CPC G06Q 30/0226

(57) ABSTRACT

There is described a method and system for creating a loyalty program involving a loyalty program provider that manages the loyalty program, a card issuer, cardholders, and participating or affiliated merchants. The loyalty program is adapted to help the loyalty card issuer to acquire and/or retain customers. A refund on purchases is provided to the cardholders by the participating merchants.

### CROSS-REFERENCE TO RELATED APPLICATIONS

This application claims priority of US Provisional Patent Application having Ser. No. 61/972,549, which was filed on Mar. 31, 2014 and is entitled “Loyalty program system and method”, the specification of which is hereby incorporated by reference.

### TECHNICAL FIELD

The present invention relates to the field of loyalty program method and systems.

### BACKGROUND

Loyalty programs are structured marketing efforts that reward, and therefore encourage, loyal buying behavior.

In marketing generally and in retailing more specifically, a loyalty card identifies a cardholder as a member in a loyalty program. By presenting the loyalty card, the cardholder is typically entitled to either a discount on the current purchase, or an allotment of points that can be used for future purchases.

Usually, the opportunities for the cardholders to accumulate points are limited since they can only accumulate points by making purchases at the card issuer's. Similarly, the options for using their accumulated points are usually limited too.

Therefore, there is a need for an improved method and system for implementing a loyalty program.

### SUMMARY

There is described a method and system for creating a loyalty program involving a loyalty program provider that manages the loyalty program, a card issuer, cardholders, and participating or affiliated merchants. The loyalty program is adapted to help the loyalty card issuer to acquire and/or retain customers. A refund on purchases is provided to the cardholders by the participating merchants. The cardholders accumulate points that may be used to buy goods or services, make a donation to a non-profit organization, transfer funds to the card issuer, etc.

In accordance with a broad aspect, there is provided a method for creating a loyalty program for a card issuer, comprising: receiving a transaction of a user made at a participating merchant, the user being provided with a membership to the loyalty program of the card issuer; calculating a transaction refund corresponding to the transaction and updating an accumulated refund accordingly; and storing the accumulated refund.

In one embodiment, the card issuer is a municipality.

In one embodiment, the accumulated refund is at least partially exchangeable for at least one of a municipal service and a municipal tax.

In one embodiment, the participating merchant is a local merchant operating in the municipality.

In one embodiment, the municipality has an agreement with an association and the accumulated refund is at least partially exchangeable for a donation to the association.

In one embodiment, the association comprises a local association operating in the municipality.

In one embodiment, the card issuer comprises an association.

In one embodiment, the association comprises one of a union, a professional order, and a political party.

In one embodiment, the accumulated refund is at least partially exchangeable for at least one a good and a service.

In one embodiment, the accumulated refund is at least partially exchangeable for a donation to the association.

In one embodiment, the card issuer comprises a company and the user is an employee of the company.

In one embodiment, the accumulated refund is at least partially exchangeable for at least one of a good and a service offered by the company.

In one embodiment, the accumulated refund is at least partially exchangeable for a membership at a social club of the company.

In one embodiment, the accumulated refund is at least partially exchangeable for a donation to an association.

In one embodiment, the association comprises a non-profit association.

In one embodiment, the participating merchant comprises the card issuer.

In one embodiment, the transaction refund and the accumulated refund each comprise a respective number of points.

In one embodiment, the transaction refund corresponds to a fixed percentage of the transaction.

### BRIEF DESCRIPTION OF THE DRAWINGS

Further features and advantages of the present invention will become apparent from the following detailed description, taken in combination with the appended drawings, in which:

FIG. 1 illustrates the entities involved in a loyalty program, in accordance with an embodiment;

FIG. 2 is a block diagram of a system for implementing the loyalty program of FIG. 1, in accordance with an embodiment; and

FIG. 3 is a flow chart illustrating a method of creating a loyalty program, in accordance with an embodiment.

It will be noted that throughout the appended drawings, like features are identified by like reference numerals.

### DETAILED DESCRIPTION

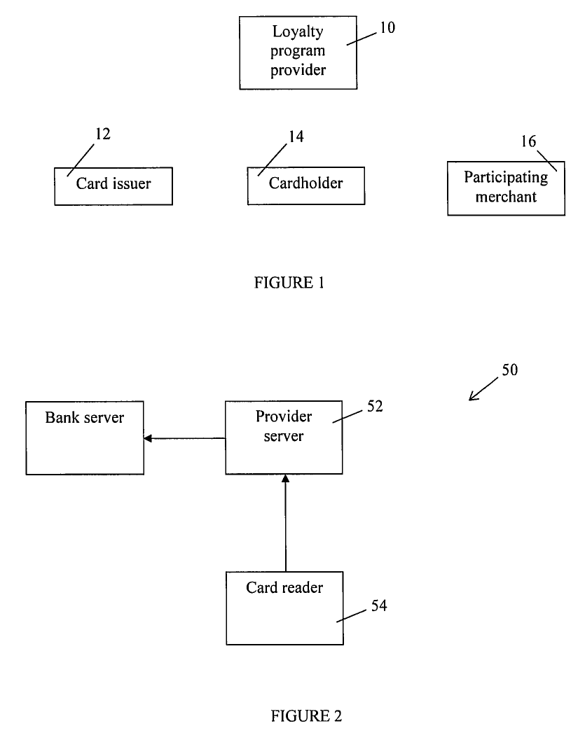

FIG. 1 illustrates the parties or entities that participate in a loyalty program, in accordance with one embodiment. The participating parties comprise a loyalty program provider 10, at least one loyalty card issuer 12, at least one cardholder 14, and at least one participating or affiliated merchant 16. In one embodiment, the loyalty program is adapted to help the participating or affiliated merchant 16 to acquire and/or retain customers, i.e. the cardholders 14. In an embodiment in which more than one card issuers 12 operate with the same loyalty program provider 10, it should be understood that the loyalty program provider 10 may develop and manage a respective loyalty program for each loyalty card issuer 12.

The loyalty program provider 10 is the entity that manages the loyalty program for the participating or affiliated merchant 16. The loyalty card issuer 12 is an entity that wishes to either acquire and/or retain customers, i.e. the cardholders 14, via the loyalty program, or to receive funds from the cardholders 14. The cardholder 14 is a person or entity that wishes to obtain a reward from the participating or affiliated merchant 16. The participating merchant 16 is an entity that wishes to acquire and/or retain customers, i.e. the cardholders 14, by participating in the loyalty program while providing refunds to the cardholders 14.

In one embodiment, the card issuer 12 is a participating merchant so that the cardholder 14 may accumulate points when he purchases goods and/or services at the card issuer 12.

Each cardholder 14 is provided with a respective loyalty program card which is associated with a loyalty program of a corresponding card issuer 12. A unique identification number is associated with each card in order to identify the cardholder 14. The loyalty program card may be a physical card such as a magnetic stripe card, a smart card, an integrated circuit card, or the like. Alternatively, the loyalty program card may be a virtual card stored on an electronic device such as a smartphone.

In one embodiment, a cardholder password is further associated with each loyalty program card.

A loyalty program associated with a given card issuer 12 comprises a list of participating merchants 16 which each agree to provide the cardholders 14 associated with the given card issuer 12 with a refund when the cardholders 14 make a purchase at the participating merchants. In one embodiment, the refund granted by the participating merchants 16 is embodied as a number of points. The number of points may be proportional to the amount of the purchase made by the cardholder 14. In one embodiment, a refund is provided for a specific list of goods and services, i.e. not all of the goods and services offered for sale by a participating merchant 16 provide a refund to the cardholder 14. For example, tobacco products may be excluded from a loyalty program so that a cardholder 14 receives no refund when he purchases a tobacco product at a participating merchant 16.

In one embodiment, the refund granted to a cardholder 14 is defined as a refund percentage of the cost of the good or service purchased by the cardholder 14. The refund is determined by applying the refund percentage, such as 2% or 3%, to the cost of the item. Then a number of points is calculated using the determined refund. For example, each refund dollar may provide one point, 10 points, or 100 points to the cardholder 14. It should be understood that different goods and services may be associated with different refund percentages.

The loyalty program provider 10 is in charge for accumulating the refunds received by each cardholder 14. For example, the loyalty program provider 10 keeps in memory the total amount of points accumulated by each cardholder 14.

The cardholder 14 may then use its accumulated refund or accumulated points to obtain a good or service, to obtain a discount on a purchase, or to donate an amount of money to an association, for example. In one embodiment, only a portion of the accumulated refund may be used by the cardholder to obtain goods and services or donate an amount of money to an association for example. In another embodiment, a corresponding monetary value is assigned to each accumulated point. In a further embodiment, a lists of goods and services available from the card issuer 12 is provided and a corresponding number of points is assigned to each good and service.

In one embodiment, the card issuer 12 is a municipality such as a township, a city, a village, or the like, and the cardholders are citizens of the municipality. The cardholders 14 accumulate a refund or points while purchasing at participating merchants. The accumulated refund or points may then be used by the cardholders to pay entirely or partially for services rendered by the municipality or a local tax. For example, the accumulated refund or points may be used by a cardholder 14 to pay at least partially a land value tax, a membership such as a municipal pool membership, a municipal library membership, and/or the like.

In one embodiment, the participating merchants are local merchants, i.e. merchants operating their business in the municipality. In this case, the loyalty program may be used by the municipality to increase local sales, i.e. increasing the purchases made at the local merchants. One of the incentives for the local citizens consists in reducing their local expenses, e.g. their expenses for municipal taxes or memberships, by locally purchasing.

In the same or another embodiment, the municipality may have an agreement with an association so that the refund or points accumulated by the cardholders may be used as a donation for the association. The association may be a non-profit association, a political party, a church, a foundation, or the like. In one embodiment, the association is a local association, i.e. an association operating in the municipality. In this case, the loyalty program associated with the municipality may be used for increasing the amount of donations for local associations.

In another embodiment, the card issuer is an association such as a union, a professional order, a political party, or the like. In this case, the cardholders 14 include the members of the association. The cardholders 14 accumulate refunds or points while purchasing goods and/or services at the participating merchants. The accumulated refund or points may then be used by the cardholders to acquire goods or services from the association. For example, the accumulated refund or points may be used by a cardholder to at least partially pay the membership of the association. In another embodiment, the accumulated refund or points may be exchanged by the cardholders for a donation to the association. For example, the accumulated refund or points may be used at least partially to make a donation to a political party.

The loyalty card may further be used by the association for identifying and managing the members.

In a further embodiment, the card issuer 12 is a non-profit organization, and the cardholders 14 include donators, volunteers, sympathizers, and/or the like. The cardholders 14 accumulate a refund or points while making purchases at the participating merchants. The cardholders 14 may then make a donation to the non-profit organization using their accumulated refund or points. Such a loyalty program may allow a non-profit organization to raise money.

In still a further embodiment, the card issuer 12 is a corporation such as a chain store or a group of corporations. The loyalty program may be adapted to help the corporation(s) to retain customers and/or acquire new customers. The cardholders 14 comprise at least some of the customers of the corporation(s). The participating merchants 16 include the stores of the card issuer corporation(s), and may also include independent merchants, i.e. stores belonging to other corporations that are not card issuers.

In an embodiment, at least two corporations may share a same loyalty program. In this case, a given corporation being part of a given loyalty program provide its customers with a loyalty program card. Each time he makes a purchase at the given corporation, a customer receives a refund. Furthermore, the customer of the given corporation also receives a refund each time he makes a purchase at another corporation that is also part of the given loyalty program. In this case, the cardholders may use their accumulated refund or points to acquire goods and/or services from any of the corporations that share the same given loyalty program.

In still another embodiment, the card issuer 12 is a company and the cardholders 14 comprise the employees of the company. In this case, the loyalty program card may then also be used by the company as an employee ID card. The cardholders 14 accumulate a refund or points each time they make purchases at participating merchants 16. The cardholders 14, i.e. the employees of the card issuer 12, may then use their accumulated refund or points to pay for their membership at the social club of the company for example. In another example in which the card issuer 12 sales goods or services, the cardholders 14 may then use their accumulated refund or points to pay at least partially for goods and services offered by their employer, i.e. the card issuer 12.

In one embodiment, the employees of the company may use their accumulated refund or points to make a donation to an association such as a non-profit organization.

In one embodiment, the present loyalty program system allows a corporation and/or participating merchants 16 to acquire or retain customers. It also allows the card issuer 12 to receive funds from the cardholders 14, and the cardholders 14 to exchange their accumulated refund for goods and/or services purchased at the corporation or participating merchant 16. The cardholders 14 may also transfer their accumulated refund to their card issuer 12.

In one embodiment, the corporations and the participating merchants 16 provide the cardholders with a fixed percentage refund on any item/service purchased by a cardholder 16, except for goods and services excluded by law, if any. It should be understood that different goods and/or services, or different types and/or services may be associated with different refund percentages. For example, the purchase of a first time of goods may provide a cardholder 14 with a first refund percentage and the purchase of a second type of goods may provide the cardholder 14 with a second and different refund percentage. The total refund for the cardholder 14 is obtained by adding the refund for the purchase of the first type of goods (which is equal to the first refund percentage multiplied by the total amount for the purchase of the first type of goods) and the refund for the purchase of the second type of goods (which is equal to the second refund percentage multiplied by the total amount for the purchase of the second type of goods).

In one embodiment, transaction fees are withdrawn from the refund granted to the cardholder 14 by the loyalty program provider 10. Then, the real refund received by the cardholder 14 corresponds to the above-calculated refund, i.e. the amount of the purchase multiplied by the refund percentage, minus the transaction fees perceived by the loyalty program provider 10. The real refund may then be converted into points which are credited to the cardholder 14.

In one embodiment, a cardholder 14 may use his accumulated points to purchase a good or service from the card issuer 12 or a participating merchant 16. The number of accumulated points is then converted into an available monetary amount which is available for the purchase. It should be understood that any adequate method for converting the number of accumulated points into a monetary amount may be used. For example, one point may correspond to one dollar, 100 points may correspond to one dollar, etc. The available monetary amount may then be used be cardholder to pay for his purchase, partially or entirely depending on the amount of the purchase.

In one embodiment, the loyalty program provider 10 withdraws no transaction fees when a cardholder 14 uses his accumulated refund or points to purchase a good or service.

In one embodiment, a cardholder 14 may not be permitted to transfer all of his accumulated refund or points to the card issuer 12 to acquire a good or service from the card issuer or make a donation to the card issuer 12. For example, a maximum amount of points or a maximum monetary amount may be set as a maximum possible transfer towards the card issuer 12. In another example, a percentage may be set to determine the maximum amount of accumulated refund or points a cardholder 14 may transfer towards the card issuer 12. For example, a cardholder 14 may use a maximum of 75% of his accumulated refund or points to make a purchase at the card issuer 12 or make a donation to the card issuer 12.

The following presents exemplary rules associated with an exemplary loyalty program.

In one embodiment the corporations and participating merchants 16 must follow the following rules:
provide a minimum 2% refund to the cardholders 14 for any purchase of a goods and/or services, except for excluded items or services such as items and/or services excluded by law;
ask all customers whether they are cardholders 14 (except for participating corporations);
allow any cardholder 14 to use its points to make a purchase; and
provide the loyalty program provider 10 with an access to their bank account to withdraw and deposit money.

The following rules apply to the cardholders 14:
before being permitted to use their points, the cardholders 14 must identify on the website of the loyalty program provider 10 by creating a user profile and a user ID;
a cardholder 14 must present his loyalty card to a participating merchant 16 and/or participating corporation in order to receive a refund;
a cardholder 14 must present his loyalty card to a participating merchant and/or participating corporation 16 and confirm his user ID in order to make a purchase via his accumulated refund or points;
no more than 75% of the accumulated refund or points may be transferred towards the card issuer 12.
the accumulated refund or points may be used to pay entirely for a purchase only if the purchase is an item or service which provide cardholders 14 with a refund;
the number of points used for purchasing a good or service of a given type cannot be greater than the number of points obtained by purchasing goods and services belonging to the same given type. For example, the number of points used for purchasing gasoline cannot be greater than the number of points obtained by the cardholder 14 by purchasing gasoline;
the number of points used for making a purchase at a given grocery store cannot be greater than the total accumulated points received for purchases made at the given grocery store;
only a limited number of accumulated points are transferrable from one loyalty card to another; and
a given number of points is deducted monthly from a loyalty card if the cardholder 14 does not use his loyalty program card during a given period of time such as one year.

The following rules apply to the card issuer 12:
provide all of their members/customers with a loyalty program card. The cardholders 14 may only comprise the members/customers having the age of majority; and
allow the loyalty program provider 10 to access the card issuer bank account for money deposits.

FIG. 2 illustrates one embodiment of a platform system 50 for implementing a loyalty program. The system 50 comprises at least a loyalty program provider server 52 and a loyalty card reader 54 which are in communication together via any adequate telecommunications network.

The server 52 is managed by the loyalty program provider 10 and comprises a processing unit, a storing unit for storing data, and a communication unit for receiving and transmitting data over the telecommunications network. A database is stored on the storing unit of the server 52. The database comprises card and cardholder information. The card information comprises at least a card ID number which may comprise 16 digits for example. The card information may also comprise a loyalty program ID which identifies the loyalty program to which the card is associated. The cardholder information may comprise the name of the cardholder, a personal identification number or password, and the like. For each card, the database further comprises the total refund or points accumulated by the cardholder.

The card reader 54 may be any adequate device adapted to read the ID of a loyalty program card. In one embodiment, the loyalty program card is a physical card such as a magnetic stripe card, a smart card, an integrated circuit card, or the like. In this case, the card reader 54 may be any electronic device adapted to read such a physical card to determine the ID of the loyalty program card. In another embodiment, the loyalty program card is a virtual card stored on an electronic device such as smart phone. In this case, the card reader 54 and the electronic device on which the virtual loyalty program card is stored each comprise a communication unit for communicating together. For example, the card reader 54 and the electronic device storing the virtual loyalty program card may remotely communicate together via near-field communication.

When a cardholder makes a purchase at a participating corporation or merchant, the loyalty program card is read by the card reader 54 to determine the card ID which is transmitted by the card reader 54 to the server 52. A participating corporation or merchant ID is further transmitted from the card reader 54 to the server 52.

In one embodiment, the card reader is adapted to determine the refund or points corresponding to the purchase or transaction. In this case, the determined refund or number of points is sent to the server 52 along with the card ID. The server 52 then receives the card ID and the refund or number of points corresponding to the purchase, and update the total refund or total number of points corresponding to the card ID accordingly.

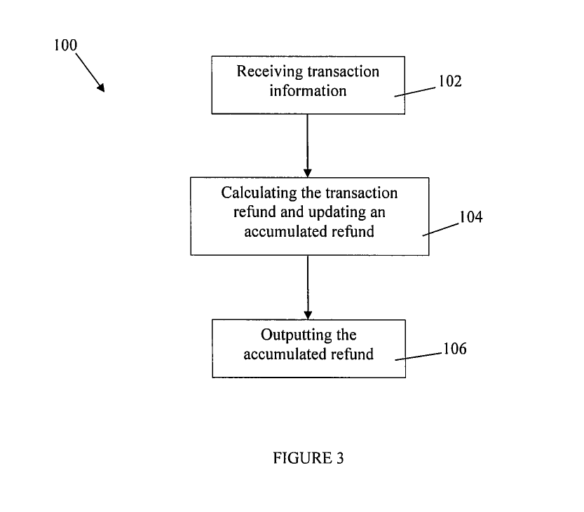

In another embodiment and as illustrated by method 100 in FIG. 3, the card reader transmits information about the purchase or transaction made by the cardholder along with the card ID. In this case, the processing unit of the server 52 is adapted to receive the transaction information such as the amount of the transaction at step 102, calculate the refund or number of points corresponding to the transaction at step 104, update the total refund or total number of points corresponding to the card ID accordingly, and output the total accumulated number of points in the database at step 108. For example, the total accumulated number of points may be stored in memory.

The server 52 is adapted to transmit the monetary amount of the refund, an identification of the bank account of the participating corporation or merchant, and an identification of the bank account of the loyalty program provider 10 to a bank server. The bank server then transfers the monetary amount from the bank account of the participating corporation or merchant to the bank account of the loyalty program provider 10.

When a cardholder 14 wants to use his accumulated refund or points to make a purchase or a donation, the card of the cardholder 14 is read by the card reader. The card ID, the amount of the purchase or donation, and an identification of the entity to which the purchase is made or the entity to receive the donation are sent from the card reader 54 to the server 52. The server 52 determines whether the accumulated refund or number of points is sufficient for the purchase or donation. If yes, the server 52 sends a confirmation message to the card reader 54 and the cardholder is authorized to make the purchase or donation. The server 52 further updates the accumulated refund or number points corresponding to the card ID.

The server 52 further determines the monetary amount corresponding to the refund or number points used by the cardholder and transmits the monetary amount as well as an identification of the entity to which the purchase is made or the entity to receive the donation to the bank server. The bank server then transfers the determined monetary amount from the bank account of the loyalty program provider 10 to the bank account of the entity to which the purchase is made or the entity to receive the donation.

In one embodiment, the cardholder may buy a good or service or make a donation to a non-profit organization while connecting to the website of the card issuer 12.

The embodiments of the invention described above are intended to be exemplary only. The scope of the invention is therefore intended to be limited solely by the scope of the appended claims.

1. A method for creating a loyalty program for a card issuer, comprising:
receiving a transaction of a user made at a participating merchant, the user being provided with a membership to the loyalty program of the card issuer;
calculating a transaction refund corresponding to the transaction and updating an accumulated refund accordingly; and
storing the accumulated refund.

2. The method of claim 1, wherein the card issuer is a municipality.

3. The method of claim 2, wherein the accumulated refund is at least partially exchangeable for at least one of a municipal service and a municipal tax.

4. The method of claim 2, wherein the participating merchant is a local merchant operating in the municipality.

5. The method of claim 1, wherein the municipality has an agreement with an association and the accumulated refund is at least partially exchangeable for a donation to the association.

6. The method of claim 5, wherein the association comprises a local association operating in the municipality.

7. The method of claim 1, wherein the card issuer comprises an association.

8. The method of claim 7, wherein the association comprises one of a union, a professional order, and a political party.

9. The method of claim 7, wherein the accumulated refund is at least partially exchangeable for at least one a good and a service.

10. The method of claim 7, wherein the accumulated refund is at least partially exchangeable for a donation to the association.

11. The method of claim 1, wherein the card issuer comprises a company and the user is an employee of the company.

12. The method of claim 11, wherein the accumulated refund is at least partially exchangeable for at least one of a good and a service offered by the company.

13. The method of claim 11, wherein the accumulated refund is at least partially exchangeable for a membership at a social club of the company.

14. The method of claim 11, wherein the accumulated refund is at least partially exchangeable for a donation to an association.

15. The method of claim 14, wherein the association comprises a non-profit association.

16. The method of claim 1, wherein the participating merchant comprises the card issuer.

17. The method of claim 1, wherein the transaction refund and the accumulated refund each comprise a respective number of points.

18. The method of claim 1, wherein the transaction refund corresponds to a fixed percentage of the transaction.
